(19) United States
(12) Patent Application Publication
(10) Pub. No.: US 2019/0228712 A1
(43) Pub. Date: Jul. 25, 2019

(54) DISPLAY DEVICE AND DRIVING METHOD THEREOF

(71) Applicants: BEIJING BOE OPTOELECTRONICS TECHNOLOGY CO., LTD., Beijing (CN); BOE TECHNOLOGY GROUP CO., LTD., Beijing (CN)

(72) Inventors: Yan LI, Beijing (CN); Bo GAO, Beijing (CN); Lingyun SHI, Beijing (CN); Wei SUN, Beijing (CN)

(21) Appl. No.: 16/325,562

(22) PCT Filed: Jul. 6, 2018
(86) PCT No.: PCT/CN2018/094746

§ 371 Date: Feb. 14, 2019

(30) Foreign Application Priority Data
Aug. 4, 2017 (CN) 201710660628.8

(51) Int. Cl. G09G 3/3266; G09G 3/36

(52) U.S. Cl. CPC G09G 3/3266; G09G 3/3677; G09G 2340/0421; G09G 2310/08; G09G 2340/0414; G09G 2310/06

(57) ABSTRACT

A display device includes a first gate driver configured to sequentially supply gate scan signals to gate lines in a first subset in response to a first timing signal, a second gate driver configured to sequentially supply gate scan signals to gate lines in a second subset in response to a second timing signal, the first subset of gate lines and the second subset of gate lines are alternately arranged, and a signal controller configured to supply respectively the first and second timing signals that are synchronized with each other to the first and second gate drivers in response to receiving an indication of a first resolution mode, and further configured to supply respectively the first and second timing signals that are time-shifted relative to each other to the first and second gate drivers in response to receiving an indication of a second resolution mode.

### CROSS-REFERENCE TO RELATED APPLICATIONS

This application claims the benefit of Chinese Patent Application No. 201710660628.8 filed on Aug. 4, 2017, the entire disclosure of which is incorporated herein by reference.

### TECHNICAL FIELD

The present disclosure relates to the field of display technologies, and in particular, to a display device and a driving method thereof.

### BACKGROUND

The physical resolution of a display is factory-customized, meaning it cannot be changed during use. It is known that the resolution with which an image is displayed on the display can be changed by means of image processing techniques. However, it would be desirable to provide more options for changing the resolution.

### SUMMARY

According to an aspect of the present disclosure, a display device is provided comprising: a display panel comprising a plurality of gate lines extending in a first direction and a plurality of data lines extending in a second direction intersecting the first direction; a first gate driver configured to sequentially supply gate scan signals to a first subset of the gate lines in response to a first timing signal; a second gate driver configured to sequentially supply gate scan signals to a second subset of the gate lines in response to a second timing signal, the gate lines in the first subset and the gate lines in the second subset being alternately arranged with each other; and a signal controller configured to supply respectively the first timing signal and the second timing signal that are synchronized with each other to the first gate driver and the second gate driver in response to receiving an indication of a first resolution mode, the signal controller further configured to supply respectively the first timing signal and the second timing signal that are time-shifted relative to each other to the first gate driver and the second gate driver in response to receiving an indication of a second resolution mode.

In some embodiments, the gate lines in the first subset comprise odd ones of the plurality of gate lines, and the gate lines in the second subset comprise even ones of the plurality of gate lines.

In some embodiments, the first resolution mode has a vertical resolution that is half of a vertical resolution of the second resolution mode.

In some embodiments, the first timing signal comprises a first vertical start signal and a first set of gate clock signals, and the second timing signal comprises a second vertical start signal and a second set of gate clock signals.

In some embodiments, the signal controller is configured to: responsive to receiving an indication of switching between the first resolution mode and the second resolution mode, adjust the first and second sets of gate clock signals accordingly during a horizontal blank interval such that the first and second sets of gate clock signals are switched accordingly between being synchronized with each other and being time-shifted relative to each other.

In some embodiments, the signal controller is configured to: responsive to receiving an indication of switching between the first resolution mode and the second resolution mode, adjust the first and second vertical start signals and the first and second sets of gate clock signals accordingly during a vertical blank interval such that the first and second vertical start signals are switched accordingly between being synchronized with each other and being time-shifted relative to each other and the first and second sets of gate clock signals are also switched accordingly between being synchronized with each other and being time-shifted relative to each other.

In some embodiments, the display device further comprises a data driver configured to supply respective data voltages to the plurality of data lines in response to a third timing signal. The signal controller is further configured to adjust the third timing signal in response to the display device switching between the first resolution mode and the second resolution mode such that the data driver supplies the data voltages in synchronization with the gate scan signals.

In some embodiments, the third timing signal comprises a horizontal start signal and a data clock signal.

According to another aspect of the present disclosure, a method of driving a display device is provided. The display device comprises: a display panel comprising a plurality of gate lines extending in a first direction and a plurality of data lines extending in a second direction intersecting the first direction; a first gate driver configured to sequentially supply gate scan signals to a first subset of the gate lines in response to a first timing signal; a second gate driver configured to sequentially supply gate scan signals to a second subset of the gate lines in response to a second timing signal, the gate lines in the first subset and the gate lines in the second subset being alternately arranged with each other; and a signal controller. The method comprises: responsive to an indication of the first resolution mode, supplying, by the signal controller, the first timing signal and the second timing signal that are synchronized with each other to the first gate driver and the second gate driver, respectively; and responsive to an indication of the second resolution mode, supplying, by the signal controller, the first timing signal and the second timing signal that are time-shifted relative to each other to the first gate driver and the second gate driver, respectively.

These and other aspects of the present disclosure will be apparent from and elucidated with reference to the embodiment(s) described hereinafter.

### BRIEF DESCRIPTION OF THE DRAWINGS

Further details, features and advantages of the present disclosure are disclosed in the following description of exemplary embodiments in conjunction with the accompanying drawings in which:

FIG. 1 schematically shows a block diagram of a display device in accordance with an embodiment of the present disclosure;

FIG. 2 schematically shows a block diagram of a gate driver in the display device of FIG. 1;

FIG. 3 schematically shows a circuit diagram of a shift register unit in the gate driver of FIG. 2;

FIG. 4 schematically shows a timing diagram of the shift register unit of FIG. 3;

FIG. 5 is a timing chart schematically showing a resolution switching process for the display device of FIG. 1; and

FIG. 6 schematically shows a flow chart of a method of driving a display device in accordance with an embodiment of the present disclosure.

Like reference signs in the figures indicate like elements. The drawings are not necessarily drawn to scale.

### DETAILED DESCRIPTION

It will be understood that, although the terms first, second, third etc. may be used herein to describe various elements, components and/or sections, these elements, components and/or sections should not be limited by these terms. These terms are only used to distinguish one element, component or section from another. Thus, a first element, component or section discussed below could be termed a second element, component or section without departing from the teachings of the present disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It will be understood that when an element is referred to as being “connected to”, “coupled to”, or “adjacent to” another element, it can be connected, coupled, or adjacent to the other element, or intervening elements may be present. In contrast, when an element is referred to as being “directly connected to”, “directly coupled to”, or “immediately adjacent to” another element, there are no intervening elements present.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

Embodiments of the present disclosure will be described in detail below with reference to the accompanying drawings.

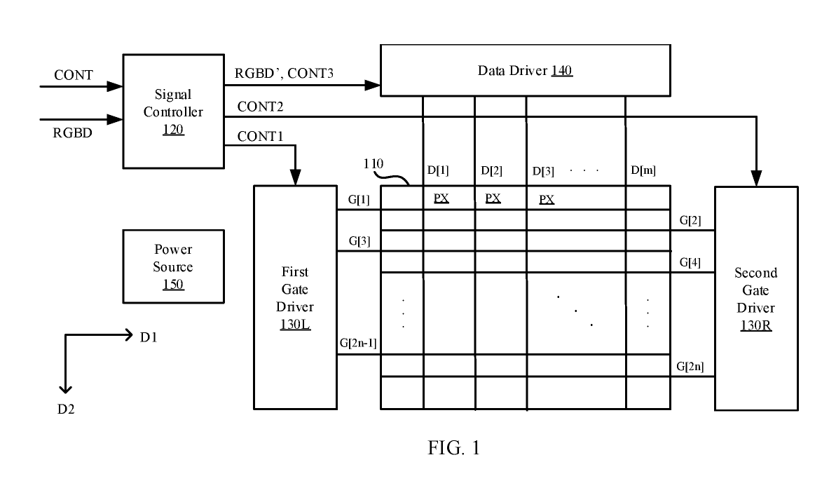

FIG. 1 schematically illustrates a block diagram of a display device 100 in accordance with an embodiment of the present disclosure.

Referring to FIG. 1, the display device 100 includes a display panel 110, a signal controller 120, a first gate driver 130L, a second gate driver 130R, a data driver 140, and a voltage generator 150. Examples of the display device 100 include, but are not limited to, a cell phone, a tablet, a television, a monitor, a laptop computer, a digital photo frame, and a navigator.

The display panel 110 is connected to a plurality of gate lines G[1], G[2], G[3], G[4], . . . , G[2n-1], G[2n] extending in a first direction D1 and a plurality of data lines D[1], D[2], D[3], . . . , D[m] extending in a second direction D2 intersecting (for example, substantially perpendicular to) the first direction D1. A plurality of pixels PX are arranged at intersections of the gate lines G[1], G[2], G[3], G[4], . . . , G[2n-1], G[2n] and the data lines D[1], D [2], D[3], . . . , D[m]. The Display panel 110 may be a liquid crystal display panel, an organic light emitting diode (OLED) display panel, or any other suitable type of display panel.

The signal controller 120, also referred to as a timing controller (T-CON), can control the operation of the display panel 110, the first and second gate drivers 130L, and 130R, the data driver 140, and optionally the voltage generator 150. The signal controller 120 receives input image data RGBD and input timing signal CONT from a system interface. The input image data RGBD may include input pixel data for the plurality of pixels PX. Each of the input pixel data may include red gradation data R, green gradation data G, and blue gradation data B for a corresponding one of the plurality of pixels. The input timing signal CONT may include a main clock signal, a data enable signal, a vertical sync signal, a horizontal sync signal, etc. The signal controller 120 generates output image data RGBD′, a first timing signal CONT1, a second timing signal CONT2, and a third timing signal CONT3 from the input image data RGBD and the input timing signal CONT.

Implementations of the signal controller 120 are known in the art. The signal controller 120 can be implemented in a number of ways (e.g., using dedicated hardware) to perform the various functions discussed herein. A “processor” is an example of the signal controller 120 that employs one or more microprocessors that can be programmed using software (e.g., microcode) to perform the various functions discussed herein. The signal controller 120 can be implemented with or without a processor, and can also be implemented as a combination of dedicated hardware that performs some functions and a processor that performs other functions. Examples of the signal controller 120 include, but are not limited to, conventional microprocessors, application specific integrated circuits (ASICs), and field programmable gate arrays (FPGAs).

The first gate driver 130L receives the first timing signal CONT1 from the signal controller 120. The first timing signal CONT1 may include a first vertical start signal and a first set of gate clock signals. The first gate driver 130L is configured to sequentially supply gate scan signals to a first subset of the gate lines G[1], G[2], G[3], G[4], . . . , G[2n-1], G[2n] in response to the first timing signal CONT1. In the example of FIG. 1, the gate lines in the first subset include odd-numbered gate lines G[1], G[3], . . . , G[2n-1].

The second gate driver 130R receives the second timing signal CONT2 from the signal controller 120. The second timing signal CONT2 may also include a second vertical start signal and a second set of gate clock signals. The second gate driver 130R is configured to sequentially supply gate scan signals to the gate lines G[1], G[2], G[3], G[4], . . . G[2n-1], G[2n] in response to the second timing signal CONT2. In the example of FIG. 1, the gate lines in the second subset include even-numbered gate lines G[2], G[4], . . . G[2n], and thus the gate lines of the first and second subsets are directly adjacent to each other.

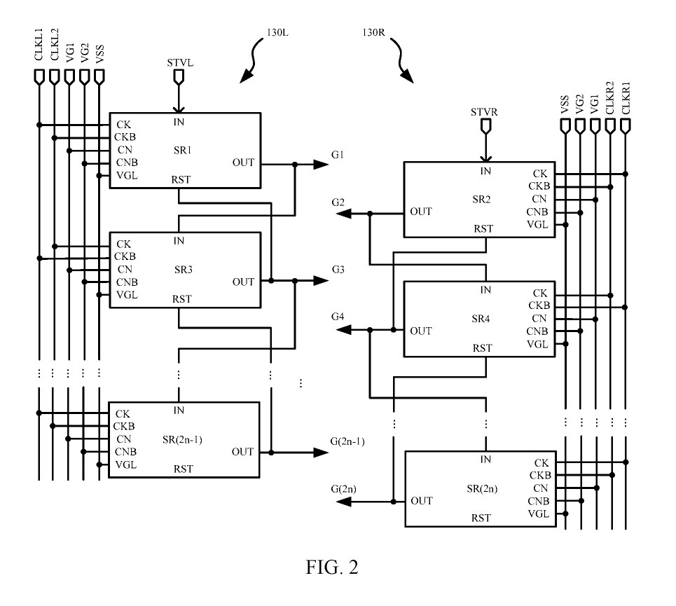

FIG. 2 schematically shows a block diagram of the first gate driver 130L and the second gate driver 130R.

The first gate driver 130L includes a plurality of cascaded shift register units SR1, SR3, . . . , SR(2n-1) (n being a positive integer), each of which has a first clock terminal CK, a second clock terminal CKB, a first reference terminal CN, a second reference terminal CNB, a power supply voltage terminal VGL, an input terminal IN, an output terminal OUT, and a reset terminal RST. The first clock terminal CK and the second clock terminal CKB are used to receive a first set of gate clock signals CLKL1 and CLKL2. The first reference terminal CN and the second reference terminal CNB are used to receive a set of reference voltages VG1 and VG2. The power supply voltage terminal VGL is used to receive a power supply voltage VSS. The input terminal IN of the first shift register unit SR1 is for receiving a first vertical start signal STVL, and the input terminal IN of each of the remaining shift register units SR3, . . . , SR(2n-1) is connected to the output terminal OUT of the directly adjacent, previous shift register unit. Except for the first shift register unit SR(1), the output terminal OUT of each of the shift register units SR3, . . . , SR(2n-1) is connected to the reset terminal RST of the directly adjacent, previous shift register unit. The shift register units SR1, SR3, . . . , SR(2n-1) output gate scan signals G1, G3, . . . , G(2n-1), respectively.

The second gate driver 130R also includes a plurality of cascaded shift register units SR2, SR4, . . . , SR(2n). In the example of FIG. 2, the second gate driver 130R may have a similar configuration to that of the first gate driver 130L. Specifically, each of the shift register units SR2, SR4, . . . , SR(2n) also has a first clock terminal CK, a second clock terminal CKB, a first reference terminal CN, a second reference terminal CNB, a power supply voltage terminal VGL, an input terminal IN, an output terminal OUT, and a reset terminal RST. Unlike the first gate driver 130L, the first clock terminal CK and the second clock terminal CKB are for receiving a second group of gate clock signals CLKR1 and CLKR2, and the input terminal IN of the first shift register unit SR2 is for receiving a second vertical start signal STVR. The shift register units SR2, SR4, . . . SR(2n) output gate scan signals G2, G4, . . . G(2n), respectively.

The first and second gate drivers 130L and 130R work together to sequentially supply gate scan signals G1, G2, G3, G4, . . . , G(2n-1), G(2n) to the gate lines G[1], G[2], G[3], G[4], . . . , G[2n-1], G[2n] of the display panel 110 of FIG. 1. In an embodiment, the first and second gate drivers 130L and 130R may be integrated on the display panel 110 as a gate driver on array (GOA). Alternatively, the first and second gate drivers 130L and 130R may be connected to the display panel 110 by, for example, a Tape Carrier Package (TCP).

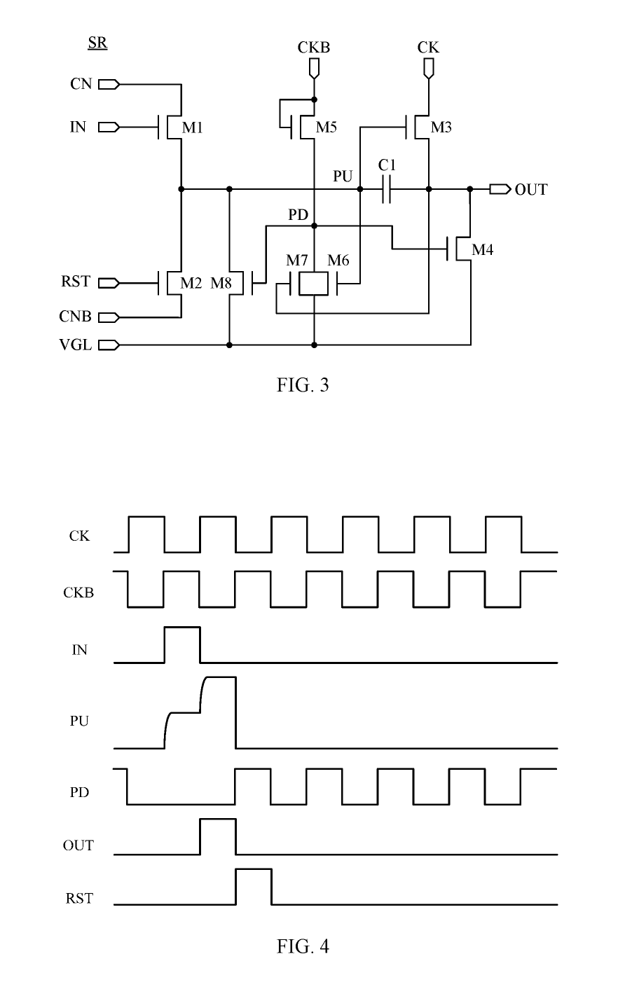

FIG. 3 schematically shows a circuit diagram of one of the gate drivers 130L and 130R of FIG. 2, and FIG. 4 schematically shows a timing diagram of the shift register unit SR of FIG. 3.

In the example of FIG. 3, the shift register unit SR includes transistors M1, M2, M3, M4, M5, M6, M7, and M8, each of which is shown as an N-type transistor. The shift register unit SR further includes a capacitor C1. The first reference terminal CN is supplied with a high level voltage, the second reference terminal CNB is supplied with a low level voltage, and the power supply voltage terminal VGL is supplied with a power supply voltage having a low level. In this case, the signals supplied to the input terminal IN, the reset terminal RST, the first clock terminal CK, and the second clock terminal CKB determine the potentials at the pull-up node PU and the pull-down node PD, which potentials, in turn, control the output at the output terminal OUT. As shown in FIG. 4, the signal output at the output terminal OUT is “shifted” by half a clock period with respect to the signal received at the input terminal IN, thereby exhibiting input-output characteristics of a shift register. In particular, the signal output at the output terminal OUT is synchronized with the clock signal received at the first clock terminal CK. This makes it possible to adjust the timing of the gate scan signal output from the gate driver 130L or 130R by adjusting the timing of the clock signals supplied to the first and second clock terminals CK and CKB.

It will be understood that the circuit shown in FIG. 3 and the timing diagram shown in FIG. 4 are exemplary, the description of which is thus simplified herein. In other embodiments, the shift register unit SR may be implemented in any other suitable configuration.

Referring back to FIG. 1, the data driver 140 receives a third timing signal CONT3 and output image data RGBD′ from the signal controller 120. The third timing signal CONT3 may include a horizontal start signal, a data clock signal, a data load signal, etc. The data driver 140 is configured to supply respective data voltages to the data lines D[1], D[2], D[3], . . . , D[m] in response to the third timing signal CONT3. In some exemplary embodiments, the data driver 140 may include a shift register, a latch, a digital to analog converter, and a buffer. The shift register outputs a latch pulse to the latch. The latch temporarily stores and outputs the output image data RGBD′ to the digital-to-analog converter. The digital-to-analog converter generates analog data voltages based on the output image data RGBD′ and outputs the analog data voltages to the buffer. The buffer outputs the analog data voltages to the data lines D[1], D[2], D[3], . . . D[m].

The voltage generator 150 can be used to supply power to the display panel 110, the signal controller 120, the first and second gate drivers 130L and 130R, the data driver 140, and potentially other components. Examples of the voltage generator 150 include, but are not limited to, a DC/DC converter and a low dropout regulator (LDO).

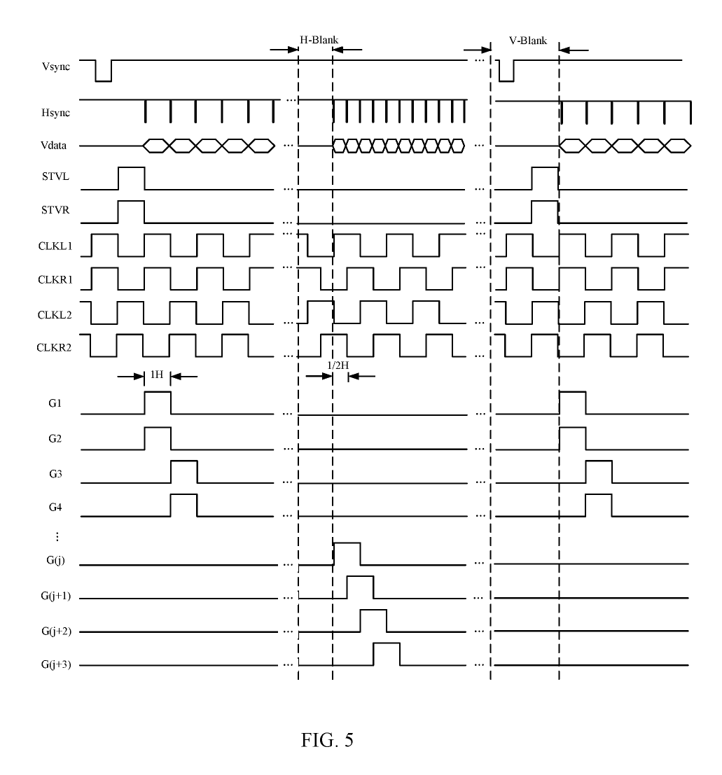

The operation of the display device 100 of FIG. 1 will be described below with reference to FIG. 5.

FIG. 5 is a timing diagram schematically showing a resolution switching process for the display device 100. In FIG. 5, Vsync and Hsync respectively indicate the vertical sync signal and the horizontal sync signal contained in the input timing signal CONT received by the signal controller 120, and Vdata indicates the data voltages output from the data driver 140 to the data lines D[1], D[2], D[3], . . . , D[m].

As previously described, the first vertical start signal STVL and the first set of gate clock signals CLKL1 and CLKL2 are supplied by the signal controller 120 to the first gate driver 130L, which in turn generates and outputs the gate scan signals G1, G3, . . . , G(2n-1) to the gate lines G[1], G[3], . . . , G[2n-1]. The second vertical start signal STVR and the second set of gate clock signals CLKR1 and CLKR2 are supplied by the signal controller 120 to the second gate driver 130R, which in turn generates and outputs the gate scan signals G2, G4, . . . , G(2n) to the gate lines G[2], G[4], . . . , G [2n].

In an embodiment, the signal controller 120 may be configured to supply the first timing signal CONT1 and the second timing signal CONT2 that are synchronized with each other to the first gate driver 130L and the second gate driver 130R, respectively, in response to receiving an indication of a first resolution mode. In the example of FIG. 5, after the first active pulse of the vertical sync signal Vsync arrives, the first and second vertical start signals STVL and STVR are synchronized with each other, and the first set of gate clock signals CLKL1 and CLKL2 and the second set of gate clock signals CLKR1 and CLKR2 are also synchronized with each other. This enables the first and second gate drivers 130L and 130L to output gate scan signals that are synchronized with each other (each of which is shown in FIG. 5 as having a pulse width of 1H). Specifically, the gate scan signals G1 and G2 are synchronized with each other, and the gate scan signals G3 and G4 are synchronized with each other, and so on. As a result, in the display panel 110, the first row of pixels PX are supplied with the same data voltages as the second row of pixels PX, and the third row of pixels PX are supplied with the same data voltages as the fourth row of pixels PX, and so on. In this case, the display panel 110 displays an image at a resolution of half of its physical resolution.

In an embodiment, the signal controller 120 may be further configured to supply the first timing signal CONT1 and the second timing signal CONT2 that are time-shifted relative to each other to the first gate driver 130L and the second gate driver 130R, respectively, in response to receiving an indication of a second resolution mode. In the example of FIG. 5, after a certain horizontal blank interval indicated by H-Blank, the first set of gate clock signals CLKL1 and CLKL2 and the second set of gate clock signals CLKR1 and CLKR2 are no longer in synchronization with each other, but are time-shifted by 1/2 H with respect to each other. This enables the first and second gate drivers 130L and 130L to output gate scan signals that are time-shifted with respect to each other. As shown in FIG. 5, the gate scan signals G(j), G(j+1), G(j+2), G(j+3), and the like are time-shifted by 1/2 H with respect to each other. As a result, in the display panel 110, respective rows of pixels PX are supplied with respective data voltages. In this case, the display panel 110 displays an image at its physical resolution. Thus, the second resolution mode has a vertical resolution that is twice the vertical resolution of the first resolution mode.

In the example of FIG. 5, the signal controller 120 achieves the switching from the first resolution mode to the second resolution mode by adjusting the first and second timing signals CONT1 and CONT2 (specifically, the first set of gate clock signals CLKL1 and CLKL2, and the second set of gate clock signals CLKR1 and CLKR2) during the horizontal blank interval H-Blank. In other embodiments, the signal controller 120 can also achieve the switching from the second resolution mode to the first resolution mode by adjusting the first and second timing signals CONT1 and CONT2 (specifically, the first set of gate clock signals CLKL1 and CLKL2, and the second set of gate clock signals CLKR1 and CLKR2) during the horizontal blank interval H-Blank. It will be appreciated that switching the resolution mode during the horizontal blank interval H-Blank allows the display device 100 to display different portions of an image at different resolutions. For example, a region of interest (ROI) of an image can be displayed at a higher resolution, and the remaining regions of the image can be displayed at a lower resolution.

Continuing with the example of FIG. 5, after the vertical blank interval V-Blank in which the second active pulse of the vertical sync signal Vsync is located, the first and second timing signals CONT1 and CONT2 are again synchronized with each other. As shown, the first and second vertical start signals STVL and STVR are synchronized with each other, and the first set of gate clock signals CLKL1 and CLKL2 and the second set of gate clock signals CLKR1 and CLKR2 are synchronized with each other. This may be achieved by the signal controller 120 adjusting the first and second timing signals CONT1 and CONT2 (specifically, the first and second vertical start signals STVL and STVR, the first set of gate clock signals CLKL1 and CLKL2, and the second set of gate clock signals CLKR1 and CLKR2) during the vertical blank interval V-Blank. In the example of FIG. 5, the signal controller 120 achieves the switching from the second resolution mode to the first resolution mode by adjusting the first and second timing signals CONT1 and CONT2 during the vertical blank interval V-Blank. In other embodiments, the signal controller 120 can also achieve the switching from the first resolution mode to the second resolution mode by adjusting the first and second timing signals CONT1 and CONT2 (specifically, the first and second vertical start signals STVL and STVR, the first set of gate clock signals CLKL1 and CLKL2, and the second set of gate clock signals CLKR1 and CLKR2) during the vertical blank interval V-Blank.

In some embodiments, the indication of the first resolution mode and the indication of the second resolution mode may be a separate command contained in the input timing signal CONT supplied from an external device (e.g., a graphics card or a master controller) and received by the signal controller 120. Alternatively, the indications may be derived by the signal controller 120 from the frequency of the horizontal sync signal Hsync contained in the input timing signal CONT. In the example of FIG. 5, the horizontal sync signal Hsync in the second resolution mode has a frequency that is twice the frequency in the first resolution mode. Therefore, the signal controller 120 can initiate the switching of the resolution mode in response to a transition of the frequency of the horizontal sync signal Hsync.

Additionally, the signal controller 120 is further configured to adjust the third timing signal CONT3 supplied to the data driver 140 in response to the display device 100 switching between the first resolution mode and the second resolution mode, such that the data driver 140 supplies the data voltages in synchronization with the gate scan signals output by the first and second gate drivers 130L and 130R. By synchronizing the operations of the data driver 140 with the operations of the first and second gate drivers 130L and 130R, the display device 100 can correctly display an image without causing display defects.

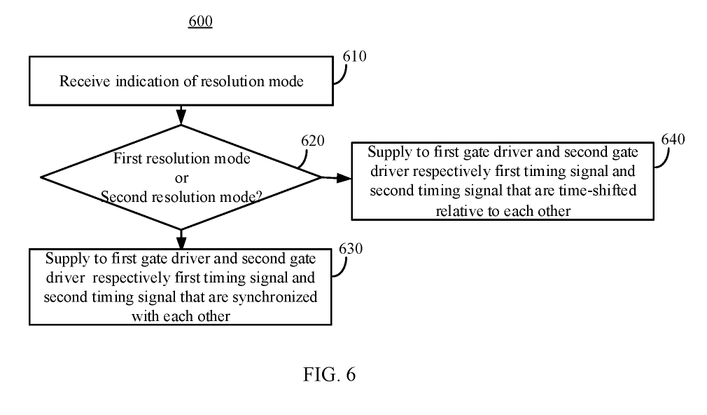

FIG. 6 schematically illustrates a flow chart of a method 600 of driving a display device in accordance with an embodiment of the present disclosure.

At step 610, an indication is received of the resolution mode. At step 620, it is determined whether the resolution mode is the first resolution mode or the second resolution mode. In response to the indication of the first resolution mode, the method 600 proceeds to step 630, where the first timing signal CONT1 and the second timing signal CONT2 that are synchronized with each other are supplied to the first gate driver 130L and the second gate driver 130R, respectively. In response to the indication of the second resolution mode, the method 600 proceeds to step 640, where the first timing signal CONT1 and the second timing signal CONT2 that are time-shifted relative to each other are supplied to the first gate driver 130L and the second gate driver 130R, respectively.

The implementation of the method 600 has been illustrated in the embodiments described above with respect to FIGS. 1-5, and thus will not be repeated for the sake of brevity.

The switching of the resolution mode of the display device can be achieved by adjusting the timing signals supplied by the signal controller to the first and second gate drivers. This provides an advantageous option for changing the resolution of the displayed image such that the user's experience of the display device can be improved in some application scenarios.

Although the present disclosure has been illustrated and described in detail in the drawings and the foregoing description, such illustration and description should be regarded as illustrative and exemplary, and not restrictive. The present disclosure is not limited to the embodiments disclosed. For example, in some embodiments, the display device may include additional gate drivers other than the first and second gate drivers. These gate drivers can be supplied with respective timing signals to enable switching to more resolution modes. In such embodiments, the gate lines of the first subset connected to the first gate driver are not necessarily directly adjacent to the gate lines of the second subset connected to the second gate driver, and there may be intervening gate lines connected to the additional gate drivers. In this context, the gate lines of such first and second subsets are still considered to be “alternately arranged.”

Variations to the disclosed embodiments can be understood and effected by those skilled in the art from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that the measures cannot be used to advantage.

1. A display device, comprising:
a display panel comprising a plurality of gate lines extending in a first direction and a plurality of data lines extending in a second direction intersecting the first direction;
a first gate driver configured to sequentially supply first gate scan signals to a first subset of the gate lines in response to a first timing signal;
a second gate driver configured to sequentially supply second gate scan signals to a second subset of the gate lines in response to a second timing signal, wherein ones of the first subset of the gate lines and ones of the second subset of the gate lines are alternately arranged with each other; and
a signal controller configured to supply respectively the first timing signal and the second timing signal that are synchronized with each other to the first gate driver and the second gate driver in response to receiving an indication of a first resolution mode,
wherein the signal controller is further configured to supply respectively the first timing signal and the second timing signal that are time-shifted relative to each other to the first gate driver and the second gate driver in response to receiving an indication of a second resolution mode.

2. The display device of claim 1,
wherein the first subset of the gate lines comprise odd ones of the plurality of gate lines, and
wherein the second subset of the gate lines comprise even ones of the plurality of gate lines.

3. The display device of claim 2, wherein the first resolution mode has a first vertical resolution that is half of a second vertical resolution of the second resolution mode.

4. The display device of claim 1,
wherein the first timing signal comprises a first vertical start signal and a first set of gate clock signals, and
wherein the second timing signal comprises a second vertical start signal and a second set of gate clock signals.

5. The display device of claim 4, wherein the signal controller is further configured to, responsive to receiving an indication of switching between the first resolution mode and the second resolution mode, adjust the first and second sets of gate clock signals during a horizontal blank interval such that the first and second sets of gate clock signals are switched between being synchronized with each other and being time-shifted relative to each other.

6. The display device of claim 4, wherein the signal controller is further configured to, responsive to receiving an indication of switching between the first resolution mode and the second resolution mode, adjust the first and second vertical start signals and the first and second sets of gate clock signals during a vertical blank interval such that the first and second vertical start signals are switched between being synchronized with each other and being time-shifted relative to each other and the first and second sets of gate clock signals are switched between being synchronized with each other and being time-shifted relative to each other.

7. The display device of claim 1, further comprising:
a data driver configured to supply respective data voltages to the plurality of data lines in response to a third timing signal,
wherein the signal controller is further configured to adjust the third timing signal in response to the display device switching between the first resolution mode and the second resolution mode such that the data driver supplies the data voltages in synchronization with the first gate scan signals or the second gate scan signals.

8. The display device of claim 7, wherein the third timing signal comprises a horizontal start signal and a data clock signal.

9. A method of driving a display device, the display device comprising a display panel comprising a plurality of gate lines extending in a first direction and a plurality of data lines extending in a second direction intersecting the first direction, a first gate driver configured to sequentially supply first gate scan signals to a first subset of the gate lines in response to a first timing signal, a second gate driver configured to sequentially supply second gate scan signals to a second subset of the gate lines in response to a second timing signal, wherein ones of the first subset of the gate lines and ones of the second subset of the gate lines are alternately arranged with each other, and a signal controller, the method comprising:
responsive to an indication of a first resolution mode, supplying, by the signal controller, the first timing signal and the second timing signal that are synchronized with each other to the first gate driver and the second gate driver, respectively; and
responsive to an indication of a second resolution mode, supplying, by the signal controller, the first timing signal and the second timing signal that are time-shifted relative to each other to the first gate driver and the second gate driver, respectively.

10. The method of claim 9,
wherein the first subset of the gate lines comprise odd ones of the plurality of gate lines, and
wherein the second subset of the gate lines comprise even ones of the plurality of gate lines.

11. The method of claim 10, wherein the first resolution mode has a first vertical resolution that is half of a second vertical resolution of the second resolution mode.

12. The method of claim 9,
wherein the first timing signal comprises a first vertical start signal and a first set of gate clock signals, and
wherein the second timing signal comprises a second vertical start signal and a second set of gate clock signals.

13. The method of claim 12, further comprising:
responsive to receiving an indication of switching between the first resolution mode and the second resolution mode, adjusting the first and second sets of gate clock signals during a horizontal blank interval such that the first and second sets of gate clock signals are switched between being synchronized with each other and being time-shifted relative to each other.

14. The method of claim 12, further comprising:
responsive to receiving an indication of switching between the first resolution mode and the second resolution mode, adjusting the first and second vertical start signals and the first and second sets of gate clock signals during a vertical blank interval such that the first and second vertical start signals are switched between being synchronized with each other and being time-shifted relative to each other and the first and second sets of gate clock signals are switched between being synchronized with each other and being time-shifted relative to each other.

15. The method of claim 9, wherein the display device further comprises a data driver configured to supply respective data voltages to the plurality of data lines in response to a third timing signal, and wherein the method further comprises:
adjusting, by the signal controller, the third timing signal in response to the display device switching between the first resolution mode and the second resolution mode such that the data driver supplies the data voltages in synchronization with the first gate scan signals or the second gate scan signals.

16. The method of claim 15, wherein the third timing signal comprises a horizontal start signal and a data clock signal.
